(19) United States
(12) Patent Application Publication
(10) Pub. No.: US 2026/0350010 A1
(43) Pub. Date: Nov. 5, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Yutaka UNO, Tokyo (JP); Masanori TSUJIKAWA, Tokyo (JP); Junya INOH, Tokyo (JP); Soma ONISHI, Tokyo (JP); Daisaku SHIBATA, Tokyo (JP)

(73) Assignee: NEC Corporation, Tokyo (JP)

(21) Appl. No.: 19/571,716

(22) Filed: Mar. 19, 2026

(30) Foreign Application Priority Data
Mar. 26, 2025 (JP) 2025-051713

(51) Int. Cl. G06F 16/2455; G06F 16/22

(52) U.S. Cl. CPC G06F 16/2455; G06F 16/2282

(57) ABSTRACT

In the information processing device, the request interpretation unit interprets the natural language information request and generates request information including information desired to be referred to. The detection unit detects the location in the database where the request information exists. The query creation unit creates a query for acquiring the information desired to be referred to from the database based on the detected location. The information acquisition unit executes the query and acquires the information desired to be referred to.

### INCORPORATION BY REFERENCE

This application is based upon and claims the benefit of priority from Japanese Patent Application 2025-051713, filed on Mar. 26, 2025, the disclosure of which is incorporated herein in its entirety by reference.

### TECHNICAL FIELD

The present disclosure relates to a technology for providing information required by a user.

### BACKGROUND ART

A medical information system that includes a relational database (RDB) storing medical information and provides information related to various hospital tasks is known. JP2015-170214A describes an example of a database system that provides medical information.

### SUMMARY

In the medical information database system, even if the user's task is the same, information to be referred to varies depending on the medical department, the disease, and the like. In addition, even if the medical department or disease is fixed, information to be referred to varies depending on the task processing style of the person in charge of the task. For this reason, a large number of graphical user interfaces (GUIs) are prepared for different task purposes. However, when a GUI design that can be used by as many users as possible is employed, a large number of information items and input items unnecessary for a specific user may be arranged. On the other hand, it is very difficult to individually prepare and manage a suitable GUI for every user.

One object of the present disclosure is to provide an information processing device that allows a user who performs various tasks to efficiently acquire necessary information.

According to an example aspect of the present invention, there is provided an information processing device comprising:
a request interpretation means for interpreting an information request in natural language and generating request information including information desired to be referred to;
a detection means for detecting a location in a database where the request information exists;
a query creation means for creating a query for acquiring the information desired to be referred to from the database based on the detected location; and
an information acquisition means for executing the query to acquire the information desired to be referred to.

According to another example aspect of the present invention, there is provided an information processing method executed by a computer, comprising:
interpreting an information request in natural language and generating request information including information desired to be referred to;
detecting a location in a database where the request information exists;
creating a query for acquiring the information desired to be referred to from the database based on the detected location; and
executing the query to acquire the information desired to be referred to.

According to still another example aspect of the present invention, there is provided a program that causes a computer to execute processing comprising:
interpreting an information request in natural language and generating request information including information desired to be referred to;
detecting a location in a database where the request information exists;
creating a query for acquiring the information desired to be referred to from the database based on the detected location; and
executing the query to acquire the information desired to be referred to.

According to the present disclosure, it is possible to provide an information processing device that allows a user who performs various tasks to efficiently acquire necessary information.

### BRIEF DESCRIPTION OF THE DRAWINGS

FIG. 1 illustrates an entire configuration of an information providing device according to the present disclosure;

FIG. 2 is a block diagram illustrating a hardware configuration of the information providing device;

FIG. 3 is a block diagram illustrating a functional configuration of the information providing device;

FIGS. 4A and 4B illustrate examples of detected tables and a relationship graph;

FIGS. 5A to 5C illustrate examples of a relationship graph and an SQL query;

FIG. 6 is a flowchart of information providing processing by the information providing device;

FIG. 7 illustrates a display example of the medical information for a user;

FIG. 8 is a block diagram illustrating a functional configuration of another information processing device according to the present disclosure; and

FIG. 9 is a flowchart of processing that the information processing device performs.

### EXAMPLE EMBODIMENTS

Preferred example embodiments of the present disclosure will be described below with reference to the drawings.

### First Example Embodiment

### Overall Configuration

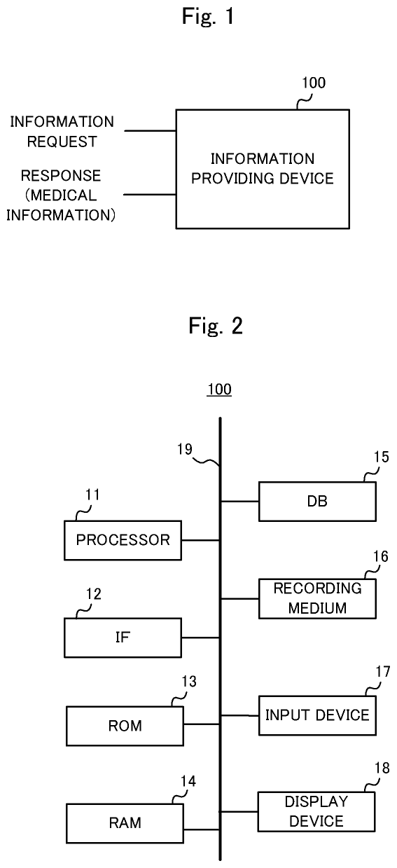

FIG. 1 illustrates an entire configuration of an information providing device according to the present disclosure. An information providing device 100 is provided in a hospital or the like, and provides medical information to a user such as a doctor or a nurse working in the hospital. The user inputs an information request to the information providing device 100. For example, the information request is for information regarding a specific patient, or related information useful for examining or treating the patient. The user can make an information request using natural language as described in detail later. That is, instead of inputting an information request in a predetermined format according to a specific GUI or the like, the user can express what kind of information the user wants in words to input the information. The information providing device 100 interprets the natural language information request input by the user, and outputs the requested medical information as a response. Specifically, the information providing device 100 outputs the response by displaying the response on a screen of a display device or the like. As a result, it is possible to provide the required information in response to the natural language information request. The information providing device 100 is an example of an information processing device according to the present disclosure.

In the present example embodiment, the information providing device 100 uses a relational database (hereinafter also referred to as “RDB”) that stores medical information. The RDB is a database that manages data in a table format. In the RDB, data is stored in a plurality of tables, and a large number of pieces of data are stored by associating the tables. Note that a system that stores, operates, controls, or otherwise processes information using the relational database is referred to as a relational database management system (RDBMS). The information providing device 100 is an example of an RDBMS.

### Hardware Configuration

FIG. 2 is a block diagram illustrating a hardware configuration of the information providing device 100. As illustrated, the information providing device 100 includes a processor 11, an interface (IF) 12, a read only memory (ROM) 13, a random access memory (RAM) 14, a database (DB) 15, a storage medium 16, an input device 17, and a display device 18. The components are connected to each other via a bus 19, for example.

The processor 11 is a computer such as a Central Processing Unit (CPU), and controls an entirety of the information providing device 100 by executing a program prepared in advance. Specifically, as the processor 11, a CPU, a graphics processing unit (GPU), a digital signal processor (DSP), a micro processing unit (MPU), a floating point unit (FPU), a physics processing unit (PPU), a tensor processing unit (TPU), a quantum processor, a microcontroller, or a combination of these can be used.

In addition, the processor 11 loads a program stored in the ROM 13 or the storage medium 16 into the RAM 14 and executes each process coded in the program. The processor 11 functions as a part or all of the information providing device 100. Specifically, the processor 11 performs information providing processing, which will be described later.

The IF 12 transmits and receives data to and from an external device. Specifically, the information providing device 100 receives an information request from the user through the IF 12. Further, the information providing device 100 can output the requested information to a storage device or an external device through the IF 12 as necessary.

The ROM 13 stores various programs to be executed by the processor 11. The RAM 14 is used as a working memory during the execution of various pieces of the processing by the processor 11.

The DB 15 includes an RDB that stores medical information as described above. In addition, the DB 15 stores various algorithms, data, a machine learning model, a deep learning model, and the like used when the information providing device 100 executes information providing processing to be described later.

The storage medium 16 is a non-volatile non-transitory storage medium such as a disk-shaped recording medium or a semiconductor memory. The storage medium 16 may be detachably attached to the information providing device 100. The storage medium 16 records various programs to be executed by the processor 11.

The input device 17 is a keyboard, a mouse, a touch panel, or the like, and is mainly used when a user inputs an information request. The display device 18 is a liquid crystal display or the like, and is mainly used to display information requested by the user.

### Functional Configuration

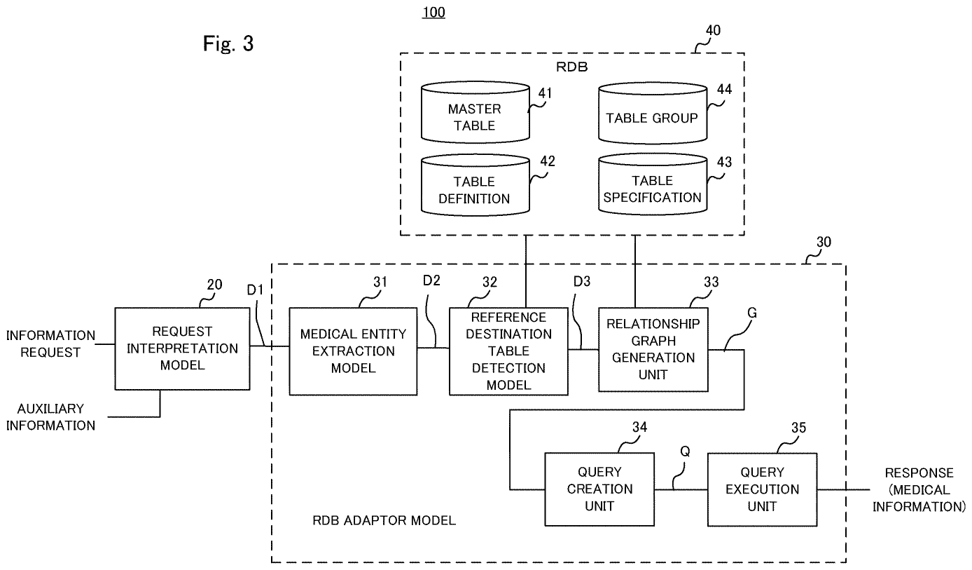

FIG. 3 is a block diagram illustrating a functional configuration of the information providing device 100. The information providing device 100 functionally includes a request interpretation model 20, an RDB adapter model 30, and an RDB 40. The request interpretation model 20 and the RDB adapter model 30 are implemented by the processor 11 illustrated in FIG. 2, and the RDB 40 is implemented by the DB 15.

First, the RDB 40 will be described. The RDB 40 includes a master table 41, a table definition 42, a table specification 43, and a table group 44. The RDB is a type of DB that stores data in a plurality of table formats, and information is stored in the table group 44 including a plurality of tables. The master table 41 is a table that manages master data which is basic data used in the RDB 40, and manages data shared throughout the RDB 40 such as “doctor information,” “patient information,” and “disease information.” The table definition 42 is information that defines a structure of a table that stores and manages data in the RDB 40, and includes, for example, definitions related to the table name, columns, a primary key, a foreign key, and the like of each table. The table specification 43 is a specification for explaining the content of definition by the table definition 42 to the user.

The request interpretation model 20 interprets the information request input by the user and estimates the information requested by the user. As described above, the information request is in natural language, and a language model such as a large language model (LLM) can be used as a request interpretation model. For example, it is assumed that the user makes the natural language information request “I want to refer to some endoscopic reports of past patients who had disease name d and symptom s.” In this case, the request interpretation model 20 interprets the content of the information request by using a language model such as an LLM, and outputs information the user desires to refer to and the conditions for referencing. In the above example, the request interpretation model 20 generates the following information (also referred to as “request information”) DI including the information the user desires to refer to and the conditions for referencing.

### Request Information D1

Information desired to be referred to: endoscope report
Conditions for referencing: disease name d, symptom s, endoscopy

Note that auxiliary information may be input to the request interpretation model 20 in addition to the information request from the user. The auxiliary information is information that assists the interpretation of the information request, and is, for example, an attribute of the user (doctor, nurse, or the like), the medical department to which the user belongs, the type of requested information (a sentence, an image, a list), or the like. The request interpretation model 20 outputs the generated request information D1 to the RDB adapter model 30.

The RDB adapter model 30 is a model that acquires the information desired to be referred to by the user from the RDB 40 based on the request information D1. The RDB adapter model 30 is configured by a trained machine learning model. Specifically, the RDB adapter model includes a medical entity extraction model 31, a reference destination table detection model 32, a relationship graph generation unit 33, a query creation unit 34, and a query execution unit 35.

The medical entity extraction model 31 extracts a medical entity of the input request information D1. The medical entity is information representing an idea, an organization, a person, a target, or the like indicated by each piece of information included in the request information D1. For example, human-related medical entities include patients, doctors, nurses, and the like, medical data-related medical entities include diagnoses, prescriptions, tests, symptoms, and the like, and disease/treatment-related medical entities include diseases, treatments, surgeries, and the like. Generally, in medical information systems, medical information is classified by medical entity and stored. The medical entity extraction model 31 has a role of identifying to which medical entity each piece of information included in the request information DI corresponds, so as to search the RDB 40 for information that the user desires to refer to.

Specifically, the medical entity extraction model 31 outputs the span (range) of the entity and the entity information from the input character string. An example in which this output is displayed in a format that can be easily understood by humans is described below as <Request Information D2 (with Medical Entities)>. The following request information D2 is output to the reference destination table detection model 32.

### Request Information D2 (With Medical Entities)

Information desired to be referred to: <t-test>endoscope<\t-test><doc>report<\doc>
Conditions for referencing: <d_p>disease name d<\d_p>, <symp>symptom s<\symp>,

In the above example, the tag <t-test> is a medical entity indicating a test, the tag <doc> is a medical entity indicating a document, the tag <d_p> is a medical entity indicating a disease, and the tag <symp> is a medical entity indicating a symptom.

The reference destination table detection model 32 determines where in the RDB 40 each piece of information included in the request information D2 is located, that is, the location of the request information D2. Specifically, the reference destination table detection model 32 refers to the table definition 42 and the table specification 43, and determines in which table in the RDB 40 the information and the medical entity to be referred to included in the input request information D2 exist. Further, the reference destination table detection model 32 determines in which row in the table the information to be referred to exists, based on the table group 44 and the medical entities of the conditions for referencing contained in the request information D2. Then, the reference destination table detection model 32 detects a table (hereinafter also referred to as a “reference destination table”) in which each piece of information included in the request information D2 exists.

The reference destination table detection model 32 searches the RDB 40 for the information desired to be referred to or information corresponding to a medical entity. It is preferable to use embedding vectors for this search. This is because the name (e.g., a disease name or the like) input as the information request by the user does not necessarily coincide with the information registered in the RDB 40. That is, while disease names and the like are registered in the RDB 40 in professional expressions, official names, and the like, the disease names input by a doctor or a nurse who is the user are often relatively general expressions, and often do not match by a simple character string comparison. Therefore, the reference destination table detection model 32 preferably calculates the similarity (e.g., cosine similarity or the like) between the embedding vector of the words included in the request information D2 and the embedding vector of information registered in the RDB 40, and detects the reference destination table in the RDB 40 in which the information included in the request information D2 exists.

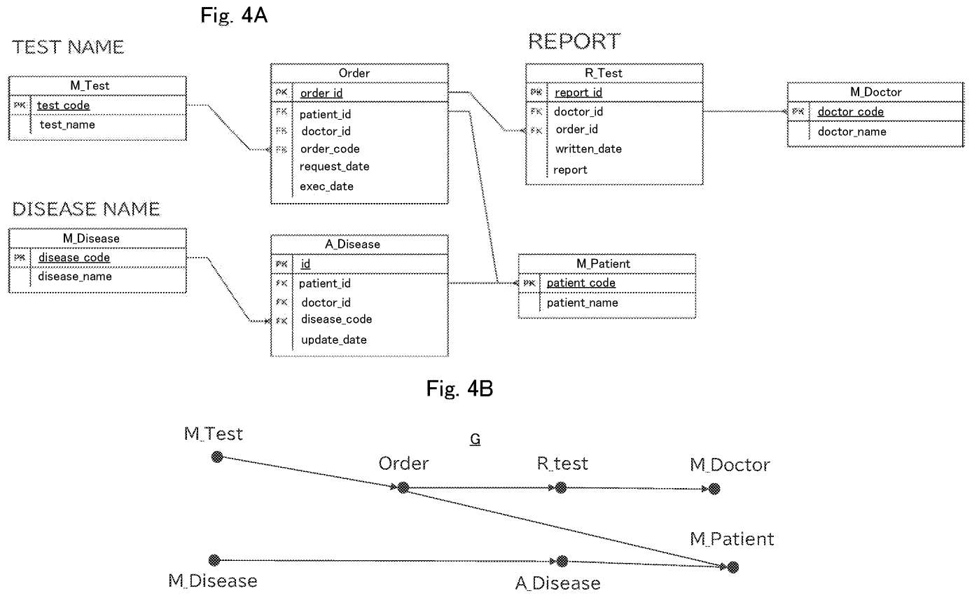

FIG. 4A illustrates an example of a table detected by the reference destination table detection model 32. The reference destination table detection model 32 detects a test name table M_Test based on the medical entity <t-test> and “endoscope” included in the request information D2, detects a disease name table M_Disease based on the medical entity <d_p> and “disease name d,” and detects a report table R_Test based on the medical entity <doc> and “report.” In this way, the reference destination table detection model 32 outputs reference destination information D3 indicating the reference destination table to which the information requested by the user belongs, to the relationship graph generation unit 33.

The relationship graph generation unit 33 searches for a path indicating a relationship between tables including information the user desires to refer to based on the reference destination information D3, and generates a relationship graph indicating the relationship between the tables. Specifically, the relationship graph generation unit 33 searches for a path between tables by tracing the correspondences between the primary keys and foreign keys included in the tables detected by the reference destination table detection model 32.

For example, in a case where the information request requests an examination report list of a patient having a specific disease, the relationship graph generation unit 33 needs to refer to a table in which patient IDs and diseases are associated with each other and a table in which the patient ID and examination reports of the patient are associated with each other. Further, in a case where information of a drug administered to the patient is requested, it is necessary to refer to a table in which the patient and the drug are associated with each other. As described above, the relationship graph generation unit 33 creates a relationship graph between tables in order to comprehensively output information of a plurality of tables including the requested information.

In the example of FIG. 4A, the relationship graph generation unit 33 generates a relationship graph G illustrated in FIG. 4B by tracing the relationships between the primary keys and foreign keys in the tables detected by the reference destination table detection model 32. In the example of FIG. 4B, the generated relationship graph G has the test name table M_Test and the disease name table M_Disease as the start points and the doctor table M_Doctor and the patient table M_Patient as the end points. Each node of the relationship graph G indicates a table, and an edge indicates a relationship between the tables. The relationship graph generation unit 33 outputs the relationship graph G thus generated to the query creation unit 34.

Note that, in an actual RDB, a large number of relationships are defined between a large number of tables, and a plurality of relationships may be defined between two tables. Therefore, when there are a plurality of paths connecting a table at a start point and a table at an end point, the relationship graph generation unit 33 generates the relationship graph G using the shortest path among the plurality of paths. As a method of selecting the shortest path among a large number of paths, for example, the Dijkstra's algorithm can be used.

The query creation unit 34 creates an SQL query based on the input relationship graph G. An SQL query is a command described according to Structured Query Language (SQL) which is a language for operating RDBs, and is used to acquire, add, update, delete, and otherwise process data in RDBs. Here, the query creation unit 34 creates an SQL query for joining a plurality of tables.

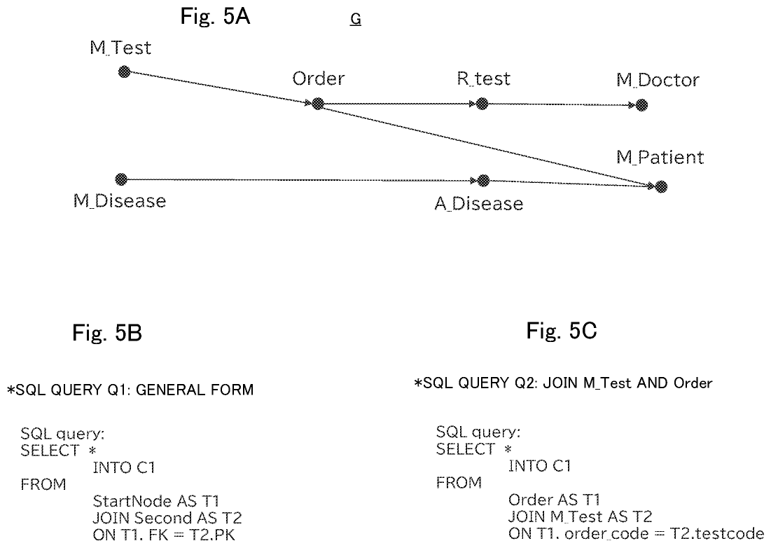

FIG. 5A shows the same relationship graph G as FIG. 4B. The query creation unit 34 creates an SQL query Q for creating one table by joining the tables included in the relationship graph G illustrated in FIG. 5A. Specifically, the query creation unit 34 creates an SQL query for joining the table M_Test with a table Order, further joining the resulting table with the table R_test, and further joining the resulting table with the table M_Doctor. In addition, the query creation unit 34 creates an SQL query for joining the table M_Disease with the table A_Disease, and further joining the resulting table with the table M_Patient. Furthermore, based on the relationship between the table Order and the table M_Patient, the query creation unit 34 creates an SQL query for creating a final joined table (hereinafter also referred to as an “output table”) by joining the table obtained by joining the tables M_Test, Order, R_test, and M_Doctor (the upper joined table of the relationship graph G) and the table obtained by joining the tables M_Disease, A_Disease, and M_Patient (the lower joined table of the relationship graph G).

FIG. 5B illustrates an example of an SQL query for joining two tables. An SQL query Q1 of FIG. 5B illustrates a general form of an SQL query for joining two tables. The SQL query Q1 sets a start node StartNode of an edge in the relationship graph G as a table T1 and an end node SecondNode as a table T2, and joins the tables using the command “JOIN” for joining tables. The equation T1.FK=T2.PK after “ON” is a table join condition, and indicates that a foreign key FK of the table T1 and a primary key PK of the table T2 are associated with each other. In the SQL query Q1, the table name of the joined table is set to “C1.”

FIG. 5C shows a specific SQL query Q2 for joining the tables M_Test and Order in FIG. 5A. The SQL query Q2 sets the table Order as the table T1, sets the table M Test as the table T2, and joins them by using the command “JOIN.” The equation T1. order_code=T2.testcode after “ON” is a table join condition, and indicates that a foreign key order_code of the table T1 and a primary key testcode of the table T2 are associated with each other. The joined table is output as the table C1.

In this manner, the query creation unit 34 creates the SQL query Q for joining the tables along the edge direction (arrow) from the start point to the end point of the relationship graph G, and outputs the SQL query Q to the query execution unit 35. The query execution unit 35 executes the input SQL query Q, and outputs an output table obtained by joining the tables included in the relationship graph G. By repeating this, a table including the request information by the user is created and output. In this way, the output table is output as a response to the information request by the user.

In the relationship graph G, there may be a plurality of start points and end points as illustrated in FIG. 5A. In that case, for the table (Order in FIG. 5A) where the path branches toward the plurality of end points, first, a join query is executed toward the end point for which only a single path exists (M_Doctor in the example of FIG. 5A), and at the same time, tables are joined along the path from the start point (M_Disease) not passing through the branching table (Order) to the end point table (M_Patient in FIG. 5A) for which paths from a plurality of start points exist. Then, by finally joining the tables obtained by the respective paths by using the path information from the branching table, it is also possible to cope with cases where there are a plurality of start points and end points.

### Information Providing Processing

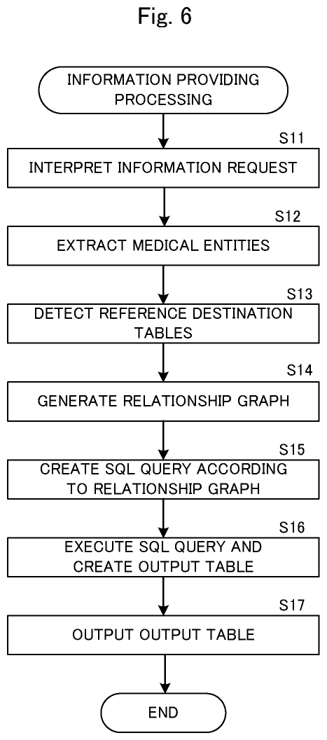

FIG. 6 is a flowchart of information providing processing by the information providing device 100. This processing is implemented by the processor 11 illustrated in FIG. 2 executing a program prepared in advance and operating as each element illustrated in FIG. 3.

First, the request interpretation model 20 interprets the information request and generates the request information D1 (step S11). Next, the medical entity extraction model 31 extracts a medical entity corresponding to each piece of information included in the request information D1, and outputs the request information D2 to which the medical entities have been added (step S12). Next, the reference destination table detection model 32 refers to the RDB 40 and detects reference destination tables in which the respective pieces of information included in the request information D2 exist (step S13).

Next, the relationship graph generation unit 33 refers to the RDB 40 based on the reference destination information D3 and generates the relationship graph G indicating the relationship between the reference destination tables (step S14). Next, the query creation unit 34 creates an SQL query for joining the tables included in the relationship graph G (step S15). Next, the query execution unit 35 executes the created SQL query, creates an output table in which the tables included in the relationship graph G are joined, and outputs the created output table as a response to the request information (step S16). In this way, an output table including the medical information corresponding to the information request by the user is output.

In the above configuration, the request interpretation model 20 is an example of a request interpretation means, the reference destination table detection model 32 is an example of a detection means, the relationship graph generation unit 33 and the query creation unit 34 are examples of a query creation means, and the query execution unit 35 is an example of an information acquisition means.

### Display Example

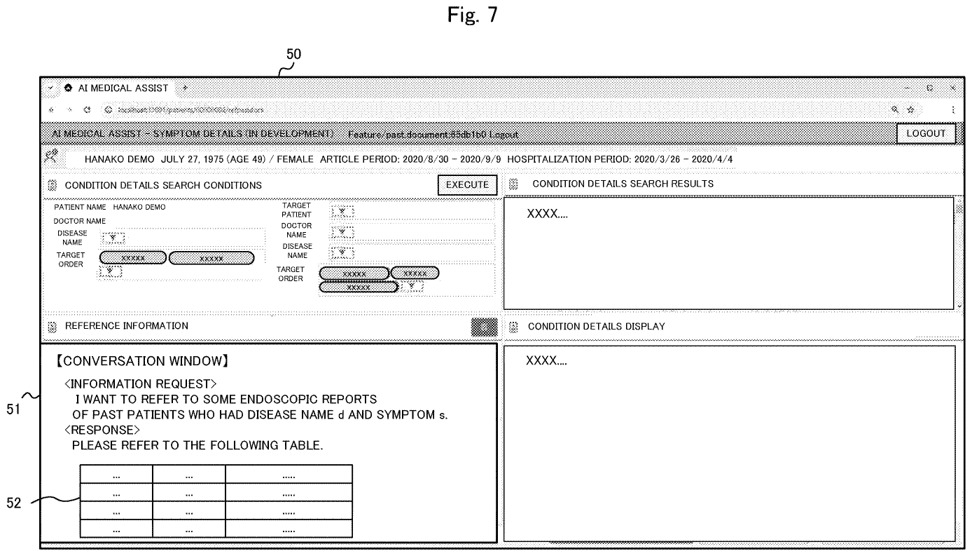

FIG. 7 illustrates a display example of the medical information for the user. FIG. 7 is an example of a display screen of the display device 18. In the example of FIG. 7, information regarding a symptom of a disease of a certain patient is displayed as the medical information. A conversation window 51 is provided at the lower left of the display screen 50. The conversation window 51 is an area in which the user inputs the information request and the response from the information providing device 100 to the information request is displayed. Specifically, in the example of FIG. 7, the user has input the information request “I want to refer to some endoscopic reports of past patients who had disease name d and symptom s.” In response, the information providing device 100 displays a table 52 including the requested information together with a sentence “Please refer to the following table.” This table 52 corresponds to an output table obtained by executing the SQL query as described above.

As described above, according to the information providing device 100 of the present example embodiment, a user such as a doctor is only required to create and input a request for desired information in natural language. Therefore, there is no need to, for example, input information in a format suitable for a specific GUI, allowing the user to make an information request that directly reflects the user's preference and desire. In addition, the information providing device 100 interprets the information request in natural language by a language model or the like, identifies the information desired by the user, automatically creates an SQL query for searching for the information, and collects the information, so that the user can easily access necessary information without knowledge about the database.

### Modifications

In the example of FIG. 7, the response from the information providing device 100 is in a table format, but the output format of the response is not limited thereto. For example, the information providing device 100 may serialize the information included in the output table and output the serialized information in text format, or may summarize and output the information using a language model.

Furthermore, for example, in a case where the user requests additional information or wants the information to be formatted in a state where the response to the information request is displayed as illustrated in FIG. 7, the user may input the request into the conversation window 51. For example, in a case where the user desires additional information for the medical information presented as the first response, more details about some information, or the like, the user may request additional information by referring to the output response (the table 52). Furthermore, in a case where the user desires the output response to be formatted (e.g., desires to change the table format, desires to specify or change the data format, etc.), the user may input the request to the conversation window 51. Since the request input to the conversation window 51 is first processed by the request interpretation model 20 that is a language model, the information providing device 100 acquires and outputs information with reference to the RDB 40 in response to a request for additional information or the like. On the other hand, for a request such as a change in the data format, it is also possible to output a response by performing processing only by the language model forming the request interpretation model.

Relational databases (RDBs) used in medical information systems include a large number of tables associated with each other, and the table name, columns, a primary key, a foreign key, and the like of each table are often managed as a table definition. In a case where a query for such an RDB is configured by identifying the reference destination based on an information request in natural language, it is difficult to identify the table or the like to be referred to due to words (abbreviations, common names, general names, etc.) input by the user not matching table names, column names, formal names, or the like registered in the RDB.

In addition, in an RDB in which a large number of tables are associated by primary keys and foreign keys, there may be a plurality of paths (join orders) between tables for reaching the same reference target. Therefore, if a query is configured without sufficiently identifying the reference destination, unnecessary table joins increase, raising issues related to computer resources such as excessive growth of the table generated after joining and an increase in query execution time.

Furthermore, a query generated based on an incorrect reference destination table or an incorrect join condition may not only cause an erroneous result but also cause a query generation that does not match the correspondences between primary keys and foreign keys as well as the columns based on the table definition, which imposes a problem from the perspectives of reliability and robustness of the search processing.

In the present disclosure, a natural language information request input by a user is structured as request information including “information desired to be referred to” and “conditions for referencing” by the request interpretation means, and where in the RDB the information included in the request information exists is identified by the detection means. As a result, even when words input by the user do not match table names or column names registered in the RDB, formal names registered in the master table, or the like, the reference destination tables can be detected by referring to the request information, the table definition 42, and the table specification 43, thereby alleviating the problem that it is difficult to identify the tables or the like to be referred to.

Further, in the present disclosure, for a plurality of reference destination tables detected by the detection means, the relationship graph generation unit generates a relationship graph indicating the relationships between tables by tracing the correspondences between primary keys and foreign keys, and the query creation means creates a joined query based on the generated relationship graph. With this configuration, even in a case where there may be a plurality of join orders in the RDB in which a large number of tables are associated, it is easier to configure a query limited to necessary joins along paths based on the relationships between primary keys and foreign keys. This suppresses problems such as an increase in unnecessary table joins, excessive growth of the table generated after joining, and an increase in query execution time.

Furthermore, in the present disclosure, the query creation means creates an SQL query based on the detected locations (reference destination tables) and the relationship graph, and the information acquisition means executes the query to acquire information desired to be referred to. This makes it possible to reduce the possibility of performing joins that do not conform to the correspondences between primary keys and foreign keys based on the table definition, and making references irrelevant to the request information. As a result, it is possible to reduce problems of reliability and robustness such as erroneous reference destinations and erroneous joining conditions, and mismatching query generation.

### Second Example Embodiment

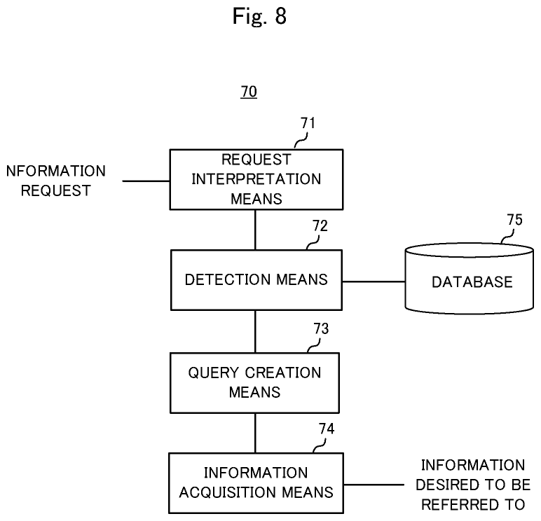

FIG. 8 is a block diagram illustrating a functional configuration of an information processing device according to a second example embodiment. An information processing device 70 includes a request interpretation means 71, a detection means 72, a query creation means 73, and an information acquisition means 74.

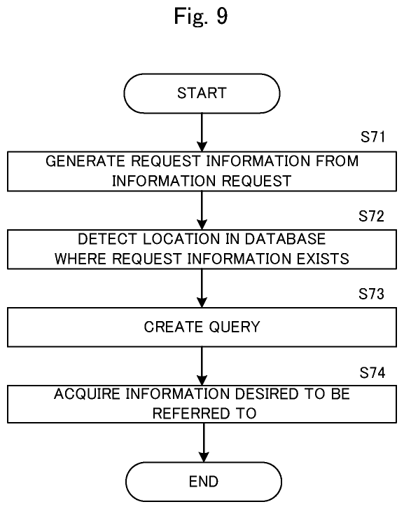

FIG. 9 is a flowchart of processing performed by the information processing device according to the second example embodiment. The request interpretation means 71 interprets the natural language information request and generates request information including information desired to be referred to (step S71). The detection means 72 detects the location in the database where the request information exists (step S72). The query creation means 73 creates a query for acquiring the information desired to be referred to from the database based on the detected location (step S73). The information acquisition means 74 executes the query and acquires the information desired to be referred to (step S74).

According to the information processing device 70 of the second example embodiment, it is possible to efficiently acquire information necessary for a user who performs various tasks.

A part or all of the example embodiments described above may also be described as the following Supplementary notes, but not limited thereto.

### Supplementary Note 1

An information processing device comprising:

1a request interpretation means for interpreting an information request in natural language and generating request information including information desired to be referred to;
a detection means for detecting a location in a database where the request information exists;
a query creation means for creating a query for acquiring the information desired to be referred to from the database based on the detected location; and
an information acquisition means for executing the query to acquire the information desired to be referred to.

### Supplementary Note 2

The information processing device according to Supplementary note 1,
wherein the database includes a plurality of tables associated with each other,
wherein the detection means detects a plurality of tables in the database in which the request information exists, and
wherein the query creation means generates a graph indicating a relationship between the tables and creates the query based on the generated graph.

### Supplementary Note 3

The information processing device according to Supplementary note 2,
wherein the detection means detects the tables in the database in which the request information exists based on the tables and definition information of the tables, and
wherein the query creation means generates the graph indicating the relationship between the tables based on the tables and the definition information of the tables.

### Supplementary Note 4

The information processing device according to Supplementary note 2, wherein the query creation means generates a graph indicating the shortest path connecting the tables, and creates a query for joining the tables according to the graph.

### Supplementary Note 5

The information processing device according to Supplementary note 1, wherein the request interpretation means interprets the information request using a language model and generates the request information.

### Supplementary note 6

The information processing device according to Supplementary note 1, further comprising an entity determination means for determining an entity of the request information,
wherein the detection means detects the location in the database where the request information exists based on the request information and the entity of the request information.

### Supplementary Note 7

The information processing device according to Supplementary note 1, wherein the detection means detects the location in the database where the request information is contained based on a similarity between an embedding vector indicating the request information and an embedding vector of information stored in the database.

### Supplementary Note 8

The information processing device according to Supplementary note 2, further comprising an output means for outputting a table obtained by joining the tables including the request information as a response to the information request.

### Supplementary Note 9

An information processing method executed by a computer, comprising:
interpreting an information request in natural language and generating request information including information desired to be referred to;
detecting a location in a database where the request information exists;
creating a query for acquiring the information desired to be referred to from the database based on the detected location; and
executing the query to acquire the information desired to be referred to.

### Supplementary Note 10

A program that causes a computer to execute processing comprising:
interpreting an information request in natural language and generating request information including information desired to be referred to;
detecting a location in a database where the request information exists;
creating a query for acquiring the information desired to be referred to from the database based on the detected location; and
executing the query to acquire the information desired to be referred to.

Some or all of the configurations described in Supplementary Notes 2 to 8 dependent on the above-described Supplementary Note 1 can also be dependent on Supplementary Notes 9 and 10 by a dependency relationship similar to that of Supplementary Notes 2 to 8. Some or all of the configurations described as the Supplementary Notes can be similarly dependent on not only the Supplementary Notes 1, 9, and 10, but also diverse pieces of hardware and software, various recording means for recording software, or systems without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

11 Processor
20 Request interpretation model
30 RDB adapter model
31 Medical entity extraction model
32 Reference destination table detection model
33 Relationship graph generation unit
34 Query creation unit
35 Query execution unit
40 RDB
41 Master table
42 Table definition
43 Table specification
44 Table group
100 Information providing device

1. An information processing device comprising:
a memory configured to store instructions; and
one or more processors configured to execute the instructions to:
interpret an information request in natural language and generate request information including information desired to be referred to;
detect a location in a database where the request information exists;
create a query for acquiring the information desired to be referred to from the database based on the detected location; and
execute the query to acquire the information desired to be referred to.

2. The information processing device according to claim 1,
wherein the database includes a plurality of tables associated with each other,
wherein the one or more processors detect a plurality of tables in the database in which the request information exists, and
wherein the one or more processors generate a graph indicating a relationship between the tables and create the query based on the generated graph.

3. The information processing device according to claim 2,
wherein the one or more processors detect the tables in the database in which the request information exists based on the tables and definition information of the tables, and
wherein the one or more processors generate the graph indicating the relationship between the tables based on the tables and the definition information of the tables.

4. The information processing device according to claim 2, wherein the one or more processors generate a graph indicating the shortest path connecting the tables, and create a query for joining the tables according to the graph.

5. The information processing device according to claim 1, wherein the one or more processors interpret the information request using a language model and generate the request information.

6. The information processing device according to claim 1,
wherein the one or more processors further configured to execute the instructions to determine an entity of the request information, and
wherein the one or more processors detect the location in the database where the request information exists based on the request information and the entity of the request information.

7. The information processing device according to claim 1, wherein the one or more processors detect the location in the database where the request information is contained based on a similarity between an embedding vector indicating the request information and an embedding vector of information stored in the database.

8. The information processing device according to claim 2, wherein the one or more processors further configured to execute the instructions to output a table obtained by joining the tables including the request information as a response to the information request.

9. An information processing method executed by a computer, comprising:
interpreting an information request in natural language and generating request information including information desired to be referred to;
detecting a location in a database where the request information exists;
creating a query for acquiring the information desired to be referred to from the database based on the detected location; and
executing the query to acquire the information desired to be referred to.

10. A non-transitory computer-readable recording medium storing a program, the program causing a computer to execute processing comprising:
interpreting an information request in natural language and generating request information including information desired to be referred to;
detecting a location in a database where the request information exists;
creating a query for acquiring the information desired to be referred to from the database based on the detected location; and
executing the query to acquire the information desired to be referred to.
